(19) United States
(12) Patent Application Publication
(10) Pub. No.: US 2002/0107834 A1
(43) Pub. Date: Aug. 8, 2002

(54) Quality assurance of data extraction

(76) Inventors: Larry Yen, South Pasadena, CA (US); Raja Balu, Westlake Village, CA (US)

Correspondence Address: Oppenheimer Wolff & Donnelly LLP, 45 South Seventh Street, Suite 3300, Minneapolis, MN, 55402-1609, US

(21) Appl. No.: 09/992,865

(22) Filed: Nov. 19, 2001

Related U.S. Application Data
(60) Provisional application No. 60/249,911, filed on Nov. 20, 2000.

(51) Int. Cl. G06F 7/00

(52) U.S. Cl. 707/1

(57) ABSTRACT

A method and system for assuring quality control during data entry. Data sheets and other input are verified for quality control. Based on the number of data entry clerks or groups and the desired level of quality, a sampling plan determines the amount of duplicated data to process for inspection. Duplicated data is created randomly and the work is distributed among the data entry clerks. Once the data is extracted into attributes, the data is consolidated and inspected for quality. A computer program is used to group attributes from the duplicated data sheets and to flag for the user those attributes that differ from the two or more data entry clerks. An inspector investigates problems and chooses the correctly entered attribute. The inspector incorporates corrective measures into the data extraction method. Once all of the differences in attribute data have been resolved, based on the number of errors present, the data sheets are either rejected and reworked, or they are accepted. Once accepted, the duplicate data is removed and the data proceeds towards insertion in a database. The database may contain such data as components or other products.

### CROSS-REFERENCE TO RELATED APPLICATIONS

This application claims the benefit of U.S. Provisional Application No. 60/249,911 filed on Nov. 20, 2000, entitled “Data extraction process with high quality level for electronic component XML,” the contents of which are incorporated herein by reference.

### BACKGROUND OF THE INVENTION

The present invention relates to data entry methods and particularly to verifying the accuracy of data entry results.

According to industry sources, the high-tech industry is projected to grow from approximately $610 billion in 1999 to approximately $1.1 trillion in 2004. While the high-tech market is growing rapidly, it is also undergoing rapid change. Although this industry has typically been characterized by complex products, volatile product life cycles and frequent product obsolescence, rapid developments in technology have magnified these characteristics. As a result, high-tech companies face increasing pressure to accelerate the development and delivery of increasingly complex products to remain competitive in their industry. Additionally, manufacturers, suppliers and distributors of technology and component parts are under comparable competitive pressure to quickly and efficiently adjust their inventory to meet the changing product development needs of their high-tech customers.

The high-tech research and development process is highly complex and consists of three logical phases—Discovery, Design and Implementation. The most crucial phase is the Discovery phase because it provides the foundation for a product's development and, if incomplete, may result in a product that is non-competitive or unprofitable, has a short life cycle or violates others' intellectual property. Rather than a linear process, the Discovery phase is an extensive, iterative and organic process, frequently requiring a collaborative, as opposed to an individual, effort. During the Discovery phase, engineers conceptualize an idea, break it down into manageable elements, identify a finite set of possible solutions for each element, test each solution against predefined performance criteria and finally select the optimal solution, while ensuring the interdependencies between each element remains intact. In one method to accomplish this, engineers: (1) create a block diagram of their concept; (2) research vast amounts of specialized information such as algorithms and standards from leading research institutions and industry forums; (3) verify the product concept against protected art to ensure uniqueness; (4) consider the optimal hardware architecture and components to implement the design; (5) investigate available firmware and software from third-party developers to determine “make or buy” decisions; and (6) repeat these steps for each block in their diagram, as many times as necessary to select the optimal component or subsystem for each block, while ensuring the interdependencies between each block remain intact.

For the Discovery process to be effective, engineers need to know what is available from all possible sources as well as what is currently in development. Traditional resources for high-tech Discovery are currently highly fragmented and decentralized, ranging from publications from research institutions, universities, standards forums, patent offices and trade journals to consultations with patent attorneys, field applications engineers and manufacturers' representatives.

Each of these sources suffers from limitations. Some publications do not contain up-to-date information and other sources of information are frequently biased because they contain data only on certain manufacturers' or distributors' products. Still others, such as dissertations or information available only by executing non-disclosure agreements (“NDAs”), are not easily accessible or, in the case of patents, understandable to engineers because they are drafted by lawyers who use their own specialized language. Similarly, consultations are typically incomplete because the knowledge or bias of the consultant limit them.

As a result, Discovery undertaken using traditional resources is costly, inefficient, time consuming, incomplete and prone to error. Moreover, the iterative nature of Discovery exacerbates these shortcomings, making it increasingly difficult for companies using traditional Discovery methods to keep pace with shorter product life cycles and higher growth expectations within the high-tech industry.

Aprisa, Inc. has introduced an interactive Discovery tool available to engineers on the Internet, under the brand name CIRCUITNET. Using this system, once an engineer has generated a system design, a database of objects is queried to find potential components or subsystems for the generic descriptions within the system design.

As one can imagine, the database of objects is expansive. Just a year after roll-out, the database includes information on over 2 million components, with 10,000 more components added monthly. Furthermore, records for each component are extensive, including the usual information regarding part number, pricing information and other attributes targeted primarily for procurement, as well as more complicated data, such as, minimum positive supply voltage, data output configuration, ADC sampling rate, and the like. Of course each type of component includes its own series of attributes available to be queried from the database.

The data making up the object database can be the ‘weak link’ of the chain. A computer system assisting engineers in the selection of components is only useful if the data is reliable. Should the data be even minimally incorrect—perhaps by as little as 1%—then reliance on the computer system is not maximized and the result is that engineers may either cease to use the system or perform independent, manual, checks on every component in a design to verify the attributes.

Unfortunately, there are many opportunities for inaccuracy of the database. Technical data sheets (and the like) are collected from manufacturers and dealers of the thousands of components listed in the database. A team of data entry clerks must then extract and convert the information from the data sheets into the proper format of data for insertion into the database. Because data entry clerks are prone to distraction, errors naturally occur during data extraction.

One solution to catch the mistakes of the data entry clerks is to perform dual-entry of the data. The dual-entry system involves two data entry clerks processing every technical data sheet. A software system then compares every entry by the two clerks and flags those entries that differ and allowing a user to choose the correct entry. A dual-entry system has disadvantages. If one of the two data entry clerks is also used to verify the data, then the data entry clerk is tempted to quickly enter data and then catch the problems during the verification process. At worst, that data entry clerk might cheat the system by entering nonsensical, garbage data, during the data entry mode and then simply choose all of the second data clerk's inputted data during verification mode. In the alternative, rather than allow either of the two data entry clerks to perform the verification, a third data entry clerk can be used. However, in such a system, not only is all of the data being entered twice—thus reducing the productivity of the data entry team by half—the process now requires three people to do the job, causing data processing costs to rise even further.

What is needed in the art is better method of verifying the integrity of converted data that is not as expensive.

### SUMMARY OF THE INVENTION

The invention is a method or system of enhancing the accuracy of converted data at a very low cost. In one embodiment, the invention is a method that accepts a batch of data in original form, extracts the desired data, converts the data into an output form, and then checks the resulting output form for inconsistencies. The inconsistencies are used for determining if there are errors affecting the entire batch. In another embodiment, some of the data from the batch is duplicated. The resulting data (both the original data and the duplicated data) is divided among a number of data entry clerks or groups, such that the duplicated data is shared by multiple data entry clerks. The data entry clerks extract the desired data into the output form. The output form corresponding to the duplicated data is inspected for inaccuracies.

In one embodiment, a sampling plan determines the amount of duplicated data to use. In another embodiment, a computer system is used to duplicate the data, divide the work among the data clerks, assist the clerks in extracting the data and converting it into output data, and to check the duplicated portion of the output data for inconsistencies. In another embodiment, an investigator looks at the inconsistencies to determine problems, to choose the correctly entered attribute, and/or to incorporate corrective measures into the data extraction method.

In one embodiment, the number of errors/inaccuracies is used to either reject the batch, or to accept the batch and transfer the data toward insertion in a database. In one embodiment, rejected batches are reworked. In yet another embodiment, a level of accuracy is chosen and used to determine whether to accept or to reject the batch. And in one embodiment, the level of accuracy is adjusted as part of the method.

It is one object of the invention to assure the quality level of data that is converted from its original form into attributes to be inserted in a database. It is another object of the invention to assure the quality level while minimizing the increase in work load of data to be processed.

### BRIEF DESCRIPTION OF THE DRAWING

FIG. 1 is flow chart diagram of one embodiment of a data factory that extracts data for a database.

FIG. 2 is a flow chart showing additional details of the work distribution process from FIG. 1.

FIG. 3 is a block diagram of a computer system used to facilitate the extraction and comparison of data.

### DETAILED DESCRIPTION OF PREFERRED EMBODIMENTS OF THE INVENTION

### Input Data 105. 110. 115

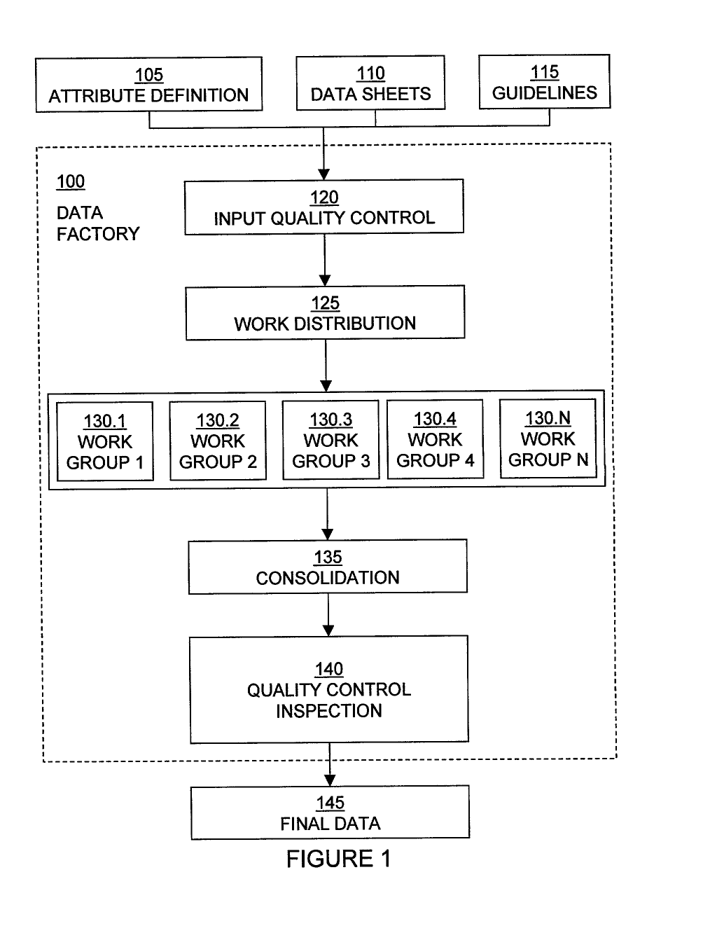

In one embodiment, the present invention is part of a data factory. FIG. 1 is a block diagram of one such data factory 100. The data factory is a methodology in which a group of data entry clerks and supervisors, assisted by specialized software tools, extract data from original sources and normalize the information so that the data is used to populate a database of components. The data factory 100 operates on input data, such as the attribute definitions 105, data sheets 110, and guidelines 115. The attribute definitions 105 are the technical information related to the major features from the product data sheets 110. They include such fields as attribute name, data type for attribute, data quantity, lower limit for the attribute, upper limit for the attribute, and keywords that act as a thesaurus for cross-referencing the various naming conventions used by different manufacturers. The attribute definitions 105 specify “what to extract.”

The product data sheets 110 specify “from where to extract.” The sheets 110 are the materials obtained from the manufacturers that contain the specifications for the various components. In one embodiment, the data sheets 110 are in an electronic form, such as a PDF document that is displayed on a computer using ADOBE's ACROBAT READER software. Or, the sheets 110 may be in HTML, JPG, DOC (as supported by MICROSOFT WORD) or other format.

The guidelines 115 are technical documents for the component category to be processed by the data factory 100. The guidelines 115 contain sections for each of the attributes to be extracted, providing information on the attribute, including: the attribute description, an explanatory note on what the attribute stands for, rules for extracting the value for the attribute under consideration from the data sheet, look up table references and conversion formulae, samples or case studies, and known exceptions. The guidelines 115 specify “how to extract.”

### Input Quality Control 120

The input data (such as attribute definitions 105, data sheets 110, and guidelines 115) enter the data factory 100 and are subjected to input quality control 120. The input data is processed by an inspection scheme so that the quality of the data is ascertained. Each of the data sheets 110 is screened to determine whether it belongs to the component category under consideration. The screening may determine that a data sheet 100 does not belong to the category, is not in fact a data sheet, or is corrupted. Then a small pilot extraction of the data for the attributes from the data sheets 110 is performed. This pilot extraction validates the attribute definitions 105 and their associated guidelines 115. The results of this pilot extraction may show that an attribute definition is unclear, that the attribute is difficult, that there is an incorrect data type or quantity, or incorrect bounds, or that there are either too many or too few keywords. Problems uncovered by the input quality control 120 process are corrected before the input data proceeds. This ensures that only valid, acceptable input data is processed by the data entry clerks.

### Work Distribution 125

The input data proceeds to the work distribution 125 phase of the data factory 100. This is the stage at which controls are put in place that will later be used for quality assurance of the output data.

Traditionally, distributing work among a team was simple. For example, when a group of workers at an assembly plant are assigned to use a kit of components to assemble a physical item, if there are materials enough to build 125 items, and there are 5 workers on the assembly line, then each worker will be assigned 125/5 (i.e., 25) items to assemble. The resulting assemblies are physically inspected for quality against a physical standard or model of the item.

The process of extracting data from a variety of data sheets does not lend itself to such a work distribution methodology. For example, to verify the results of a data entry team, a supervisor would have to recheck the work manually. This is not feasible.

The present invention's method of ensuring quality in data entry teams works by assigning a certain number of the data sheets 110 to more than one data entry clerk. These duplicated data sheets will result in duplicated extractions of attributes. The duplicated attributes are compared to determine whether the team has extracted data accurately.

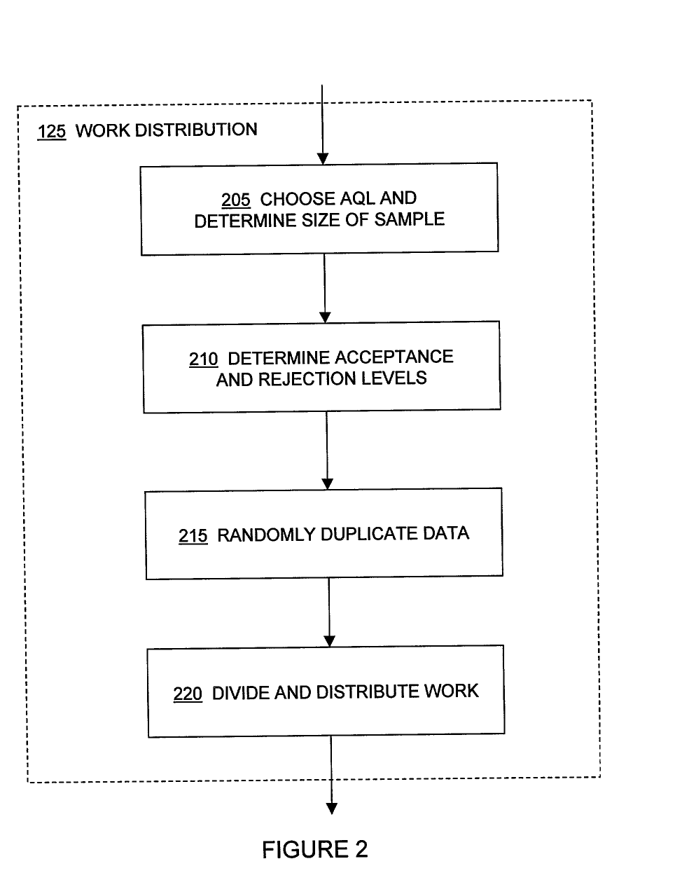

There are two types of duplication used by the present invention. The number of data sheets 110 to be duplicated can be varied as well as can the number of data entry clerks to receive the same data sheet 110. The number of data sheets to duplicate, or overlap, is the chief parameter used to assure quality of the team. FIG. 2 is a flow chart showing additional details of the work distribution process from FIG. 1. As shown in FIG. 2, an Acceptable Quality Level (AQL) is chosen 205. Once the AQL is chosen, any of several statistical methods are used to determine the amount of data sheet duplication needed. These methods provide Sampling Plans that are set up with regard to the desired AQL.

In one embodiment of the present invention, the Sampling Plan that has evolved from the Plan developed by the U.S. Government during World War II is used. This standard, known as Mil. Std. 105D, was issued by the U.S. government in 1963. It was adopted in 1971 by the American National Standards Institute as ANSI Standard Z1.4 and in 1974 it was adopted (with minor changes) by the International Organization for Standardization as ISO Std. 2859. Mil. Std. 105D, as used in the present invention, offers three types of sampling plans: single, double and multiple plans. After choosing the AQL, the “inspection level” must be chosen. The inspection level determines the relationship between the lot size and the sample size. Mil. Std. 105D offers three general and four special levels. In one embodiment, the present invention uses Level 1.

The number of data sheets 110 to be processed, in connection with the level and AQL, is used to retrieve from the Sampling Plan the size of the sample 205—in other words, how many data sheets 110 must be duplicated. In addition, Acceptance and Rejection Levels are both calculated 210. The Acceptance Level is the maximum number of errors that are allowable in the extraction process in order to meet the quality levels set forth. The Rejection Level is the number of errors beyond which the extracted data is to be rejected, as it will not meet the quality standards desired.

The second type of duplication—the number of overlaps—is used to fine-tune the extraction process. The present invention may start with two overlaps, meaning that each duplicated data sheet 110 will be distributed to two data entry clerks. If the performance of data extraction is not satisfactory, then by increasing the number of overlaps, the present invention's control over quality is tightened. While the quality of the extract data improves greatly as the number of overlaps increases, the addition of such a high amount of duplicated work keeps the data entry team from maximizing their output.

After the sample size, rejection level, acceptance levels, and number of overlaps are determined, the work distribution phase 125 randomly duplicates the correct number of data sheets (step 215) and then divides and distributes the work (step 220) to the data entry team, which may be made up of N-number of data entry clerks 130, or N-number of data entry work groups 130. Care must be taken to have a large enough number of data sheets 110 so that no two data entry clerks discover that the data sheets have been duplicated. Should the data entry clerks realize that a portion of their work is extraneous, they may not be as diligent in extracting data as they otherwise would be.

### Quality Control Inspection 140

The data entry clerks process the data sheets 110, extracting data for the attributes that are to be inserted into the database. When all of the data sheets 110 for a given lot are completed, the data is consolidated 135 and is ready for quality control inspection 140. Such inspection involves comparing the attributes extracted from the duplicated data sheets 110. When a variation occurs in the data extracted by two of the data entry clerks, then an inspector flags the error and must choose which attribute is correct by viewing the data sheet 110. In one embodiment, the inspector also determines the corrective action for mistakes found for the data entry clerks or work groups. For example, additional training or updated guidelines 115 avoid the data entry clerks from making a similar error in the future. At the end of the inspection phase, the final total number of errors found in the lot or batch is compared to the Acceptance and Rejection Levels.

If the number of errors equals or exceeds the Rejection Level then the inspection goes into rejection mode. The rejected lot must be reworked by the work group 130 and then resubmitted for inspection 140. This repeats until the AQL level is achieved.

When the final total number of errors found in the lot is less than or equal to the Acceptance Level, then the inspection goes into acceptance mode. The duplicate attributes are removed from the data and the final data 145 proceeds for further processing before insertion in the database.

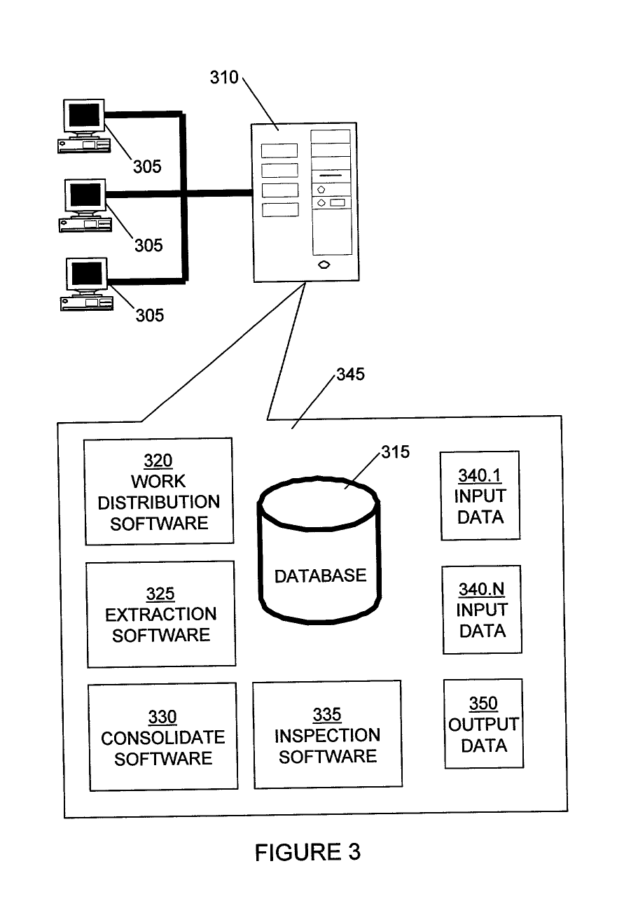

In some embodiments, the present invention comprises one or more software tools developed to assist a human user to perform some of the tasks in the data factory 100. FIG. 3 is a block diagram of one embodiment of a computer system to do so. In FIG. 3, a series of client computers 305, such as PCs or workstations, are connected by a network to a server or central computer 310. The server computer 310 has a memory 345 that stores data and software. Memory 345 is primary memory within the server computer 310 or secondary memory, such as a disk drive unit. One software module or tool stored in memory 345 is used for the work distribution phase 320. Such software accepts as input the path and filename for the attribute definition file 105, the directory where the PDF version of the data sheets 110 are found, and a folder in which to place the distributed work 125. In some embodiments, the input data 340 is stored on the server's memory 345. The number of data entry clerks is selected. The software 320 then uses a computerized version of a Sampling Plan to determine the sample size (based on the number of data sheets 110 within the specified directory). The Acceptance Level and Rejection Levels are also computed. In some embodiments, the user of the software also indicates the number of overlaps to use (to fine tune the data factory 100), or the system defaults to usual two overlaps. The software 320 then randomly duplicates the proper number of data sheets 110, and divide the data sheets 110 among the work groups 130 or data entry clerks 130. Extraction software 325 is used by a data entry clerk 130 to view his or her portion of the input data 340 that needs to be worked. The extraction software 325 assists by highlighting probable fields for extraction and allows the clerk to cut-and-paste data to form output data 350. Once all of the data for a batch is worked by the data entry clerks, output data is consolidated by software 330 to form the group's comprehensive output data 350.

Inspection software 335 is then used to assist with the inspection for quality control phase 140. The software 335 groups the duplicated extracted attributes and displays the differences side by side for the inspector to see. The inspector investigates the problem and chooses the proper version of the attribute. Once all of the errors have been inspected, the software 335 provides displays or reports of the errors, including the number of errors in the lot and whether the lot should be accepted or rejected based on the acceptance and rejection levels. If accepted, the output data 350 is further processed before being inserted into the database 315.

One skilled in the art will realize that such software shown in FIG. 3 can be implemented in various computer languages, including C++, Java, and Visual Basic. It is also anticipated that the software can be implemented on a single PC, such that the client 305 and server 310 shown in FIG. 3 are the same piece of hardware. Of course, additional functionality can be incorporated in such software to make the data factory 100 operate more efficiently. For example, the software could be configured with enough information so that it could identify which attribute from duplicated data sheets 110 is likely to be correct, thus making the inspector's job much easier.

### Extracting Data for a Database of Components used in Discovery

With respect to the foregoing discussion of data extraction, during the Discovery step of research and development, an engineer generates a block diagram of a system to be designed. The block diagram is made up of a series of interconnected blocks. Each of these blocks represents a component or subsystem (since systems are often hierarchical, containing various levels of subsystems and components). Throughout this application, the use of “component” refers not only to true components, but also includes subsystems.

One of the primary goals of the Discovery phase is for the engineer to create a conceptual design of a product that can then be used in the Design phase to create manufacturable specifications. In Discovery, an engineer refines a design of a system by researching each of the design's components to come up with a near-optimal solution of the exact components that should be used. The near-optimal solution is based on the compatibility of the various components as well as various predefined criteria. Choosing which element to use for each component of a design is very difficult because there are numerous factors to take into account. Price and availability are two such factors. Compatibility with the rest of the components to be placed in the design is another factor. Due to the number of manufacturers for any given category of product, and because all of these manufacturers are continually introducing new and improved products, an engineer is challenged with an ever increasing amount of information to consider during Discovery.

Newer Discovery tools, such as Applicant's CIRCUITNET tool, provide databases that store product and design related objects, including systems, subsystems, micro-systems, components, products, vendors, and other sub-units. In one embodiment, such a database can be a SQL database on an NT server.

Creation and maintenance of the database are not simple tasks. To be effective, the database must be extensive, having a wide range of information on components. All of this information must supervised by human data entry clerks since the information to be added is not in a standard format. The present invention, with its method of ensuring quality during data extraction is used to build databases, such as used by the CIRCUITNET tool. Data sheets and the like are distributed to work groups such that duplicated data is also distributed. The work groups extract the data. The data is consolidated and inspected. Based on the results of the extraction of the duplicated data, the database can be populated with the new component information.

From the foregoing detailed description, it will be evident that there are a number of changes, adaptations and modifications of the present invention which come within the province of those skilled in the art. However, it is intended that all such variations not departing from the spirit of the invention be considered as within the scope thereof. The method described herein to assure quality control can be used for any type of data entry and is not limited to extracting data from data sheets relating to components used by engineers.

What is claimed is:

1. A method for testing output quality from a data extraction process, comprising:
receiving input data containing information to be inserted into a database;
dividing the input data into a plurality of batches such that a subset of the input data is duplicated among the plurality of batches;
distributing the plurality of batches to a plurality of data entry clerks, wherein each data entry clerk processes one of the plurality of batches and converts data from the batch into worked data;
receiving the worked data from each of the plurality of data entry clerks; and
inspecting the subset of the worked data corresponding to the duplicated subset of the input data to determine the accuracy of the subset of worked data.

2. The method for testing output quality from claim 1, wherein the step of inspecting predicts the quality of the worked data.

3. The method for testing output quality from claim 1, wherein the subset of the input data duplicated among the batches is based on a sampling plan.

4. The method for testing output quality from claim 1, further comprising repeating the steps of dividing, distributing, receiving and inspecting, if a desired level of accuracy is not reached.

5. The method for testing output quality from claim 1, further comprising adjusting the desired level of accuracy based on inspecting the subset of the worked data.

6. The method for testing output quality from claim 1, wherein the step of inspecting the subset of the worked data comprises:
identifying the subset of the worked data resulting from the duplicated subset of the input data;
comparing entries made by each of the plurality of data clerks on the subset of the worked data; and
flagging the entries that differ.

7. The method for testing output quality from claim 1, wherein the step of inspecting the subset of the worked data comprises: accepting the worked data for submission to a database if the desired level of accuracy is met and rejecting the worked data for submission to the database if the desired level of accuracy is not met.

8. The method for testing output quality from claim 1, wherein the input data is a plurality of technical product data sheets.

9. The method for testing output quality from claim 1, wherein the steps of dividing, distributing, receiving and inspecting are accomplished with a computer system.

10. A data extraction tool implemented on a computer, the tool comprising:
a first receiver unit for receiving input data containing information to be inserted into a database;
a data divider unit for dividing the input data into a plurality of batches such that a subset of the input data is duplicated among the plurality of batches;
a distributor unit for distributing the plurality of batches to a plurality of data entry clerks, wherein each data entry clerk processes one of the plurality of batches and converts data from the batch into worked data;
a second receiver unit for receiving the worked data from each of the plurality of data entry clerks; and
an inspector unit for inspecting the subset of the worked data corresponding to the duplicated subset of the input data to determine the accuracy of the subset of worked data.

11. The data extraction tool implemented on a computer from claim 10, wherein the inspector unit predicts the quality of the worked data.

12. The data extraction tool implemented on a computer from claim 10, wherein the subset of the input data duplicated among the batches is based on a sampling plan.

13. The data extraction tool implemented on a computer from claim 10, further comprising reworking the batch using the distributor unit, second receiver unit, and inspector unit, if a desired level of accuracy is not reached.

14. The data extraction tool implemented on a computer from claim 10, further comprising adjusting the desired level of accuracy based on the inspector unit inspecting the subset of the worked data.

15. The data extraction tool implemented on a computer from claim 10, wherein the inspecting of the subset of the worked data performed by the inspector unit comprises:
identifying the subset of the worked data resulting from the duplicated subset of the input data;
comparing entries made by each of the plurality of data clerks on the subset of the worked data; and
flagging the entries that differ.

16. The data extraction tool implemented on a computer from claim 10, wherein the inspecting of the subset of the worked data performed by the inspector unit comprises: accepting the worked data for submission to a database if the desired level of accuracy is met and rejecting the worked data for submission to the database if the desired level of accuracy is not met.

17. The data extraction tool implemented on a computer from claim 10, wherein the input data is a plurality of technical product data sheets.

18. A computer program for a data extraction tool, the computer program embodied on a computer readable medium for execution by a computer, the computer program comprising:
a code segment that receives input data containing information to be inserted into a database;
a code segment that divides the input data into a plurality of batches such that a subset of the input data is duplicated among the plurality of batches;
a code segment that distributes the plurality of batches to a plurality of data entry clerks, wherein each data entry clerk processes one of the plurality of batches and converts data from the batch into worked data;
a code segment that receives the worked data from each of the plurality of data entry clerks; and
a code segment that inspects the subset of the worked data corresponding to the duplicated subset of the input data to determine the accuracy of the subset of worked data.

19. The computer program for a data extraction tool from claim 18, wherein the code segment that inspects the data predicts the quality of the worked data.

20. The computer program for a data extraction tool from claim 18, wherein the subset of the input data duplicated among the batches is based on a sampling plan.

21. The computer program for a data extraction tool from claim 18, further comprising reworking the batch using the code segment that distributes, the code segment that receives, and the code segment that inspects, if a desired level of accuracy is not reached.

22. The computer program for a data extraction tool from claim 18, further comprising adjusting the desired level of accuracy based the code segment that inspects inspecting the subset of the worked data.

23. The computer program for a data extraction tool from claim 18, wherein the step of inspecting performed by the code segment that inspects comprises:
identifying the subset of the worked data resulting from the duplicated subset of the input data;
comparing entries made by each of the plurality of data clerks on the subset of the worked data; and
flagging the entries that differ.

24. The computer program for a data extraction tool from claim 18, wherein the step of inspecting performed by the code segment that inspects comprises: accepting the worked data for submission to a database if the desired level of accuracy is met and rejecting the worked data for submission to the database if the desired level of accuracy is not met.

25. The computer program for a data extraction tool from claim 18, wherein the input data is a plurality of technical product data sheets.
